(19) United States
(12) Patent Application Publication
(10) Pub. No.: US 2004/0193326 A1
(43) Pub. Date: Sep. 30, 2004

(54) Motor driven flow control and method therefor

(76) Inventors: Terry G. Phillips, Meridianville, AL (US); Wade C. Patterson, Huntsville, AL (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/727,403

(22) Filed: Dec. 4, 2003

Related U.S. Application Data
(63) Continuation-in-part of application No. 10/285,377, filed on Oct. 31, 2002.
(60) Provisional application No. 60/430,859, filed on Dec. 4, 2002.
(60) Provisional application No. 60/335,721, filed on Nov. 1, 2001.

(51) Int. Cl. G05D 7/00

(52) U.S. Cl. 700/282; 137/624.11

(57) ABSTRACT

An electronically controlled valve assembly is disclosed. The electronically controlled valve assembly includes a valve cartridge including a valve; and a motor coupled to the valve cartridge to control movement of the valve in response to an electronic control signal. An electronically controlled fluid dispensing apparatus and a method of electronically controlling fluid dispensation are also disclosed.

### CROSS REFERENCE TO RELATED APPLICATIONS

This application claims priority to U.S. Provisional Application No. 60/430,859, filed on Dec. 4, 2002, and entitled “Motor Driven Flow Control and Method Therefor,” which is hereby incorporated herein by reference. In addition, this application is continuation-in-part of and claims priority to U.S. patent application Ser. No. 10/285,377, filed on Oct. 31, 2002, and entitled “Apparatus and Method for Electronic Control of Fluid Flow and Temperature,” which is hereby incorporated herein by reference. U.S. patent application Ser. No. 10/285,377 claims priority to U.S. Provisional Application No. 60/335,721 filed on Nov. 1, 2001, and entitled “Apparatus and Method for Electronic Control of Fluid Flow and Temperature,” which is hereby incorporated herein by reference.

### BACKGROUND OF THE INVENTION

1. Field of the Invention

The present invention relates generally to the field of fluid dispensation, and more particularly, to an apparatus and method for electronically controlling the flow of fluid dispensed from a fluid dispensing device.

While the present invention is applicable of use with any number of fluid dispensing devices, it is particularly well suited for use with faucets, water coolers, shower heads, toilets, and the like.

2. Technical Background

Various methods have been employed to electronically control fluid flow through a fluid dispensing device such as a faucet, toilet, showerhead, or the like. Generally speaking, faucets and other fluid dispensing devices incorporating one or more sensors for the automatic control of the flow of fluid through a faucet or other device are well known in the art. A common approach is to employ a sensor, typically in combination with some type of emitter, which, together with processing electronics, control one or more solenoid valves that open or close to either initiate or terminate, respectively, fluid flow through the fluid dispensing device. Generally speaking, the prevailing sensing technology available on the market today is infrared (“IR”) technology. In accordance with typical IR sensing technology, a pulsed IR beam from an IR source is reflected from an object, such as a user's hands, and sensed to determine whether to activate or deactivate the one or more solenoid valves. Pulsed IR sensing remains at the forefront of sensing techniques used with these types of devices, due in part to its reasonable performance and low cost. Those of skill in the art will recognize, however, that other types of proximity detectors are also utilized to sense the presence of an object adjacent a faucet or other fluid dispensing device, and activate a solenoid valve in response thereto.

FIG. 1 illustrates a conventional automatic faucet assembly 10 known in the art. The faucet assembly 10 includes a body 12 having a water inlet 14 and a water outlet 16. As is known in the art, the body 12 may be chrome plated, solid brass, or some other conventional construction. The body 12 may be secured to a sink or countertop surface 18 by one or more fastening mechanisms such as studs 20 and nuts 22. Water inlet 14 passes through a hole in the counter top 18 and is connected to a solenoid valve 24. The connection to the solenoid valve is illustrated in FIG. 1 as a flexible pipe 26. In other embodiments, solenoid valve 24 may be connected to water inlet 14 by a copper tube, direct connection of the solenoid valve 24 to the water inlet 14, or by other conventional techniques, as are known in the art.

In operation, water is typically supplied to an inlet 27 of the solenoid valve 24. When the solenoid valve 24 is in an open position, a flow of water passes through solenoid valve 24, to the water inlet 14, through the body 12, and thereafter, to the water outlet 16. An in-line filter 28 may be provided at the inlet of the solenoid valve 24. The water supplied to the faucet assembly 10 may be a single temperature, such as cold water alone, or may be a blend of cold and hot water provided through a mixing device as is known in the art. Alternatively, body 12 may be formed to have two inlets for the individual supply of hot and cold water for mixing within passages in the body 12 prior to flowing through outlet 16.

A mechanism for controlling the solenoid valve 24 may include circuitry, as is known in the art, housed within a control box 30 located proximate the faucet body 12 and solenoid valve 24. Control box 30 may be a sealed, waterproof enclosure for protecting the enclosed electrical circuitry. The mechanism for controlling the solenoid valve may also includes a sensor located within a sensor housing 32 installed on an underside of body 12 in an area proximate the location of a users hands while operating the faucet. The sensor may be connected to control circuitry located within the control box 30 by an armored cable 34.

Generally speaking, there are a number of shortcomings associated with the use of solenoid valves in connection with electronically controlled fluid dispensing devices such as that described above with respect to FIG. 1. For example, line debris may enter the solenoid valve when water is passed therethrough, which may clog the solenoid valve and inhibit its proper operation. Similarly, prolonged use will likely result in the build-up of mineral deposits and other materials carried by the water passing through the solenoid valve. In either or both cases, complete closure of the solenoid valve may be prevented, which will likely lead to a leaking faucet. After an extended period of time, such deposits and/or build-up may result in the complete failure or disablement of the solenoid valve. Generally speaking, such issues will generally require the replacement of the entire solenoid valve, which is an expensive and time consuming task.

Another shortcoming associated with the use of commercially available fluid dispensing devices relates to the limited number of aspects of fluid dispensation that are presently capable of being controlled. Generally speaking, commercially available electronically controlled fluid dispensing devices are capable of either turning fluid flow on or off, or controlling the fluid temperature. None of the devices presently available on the market provide for flow and flow rate control of fluid dispensation. Specifically, no one device known in the art is presently capable of turning fluid flow on and off, and controlling the fluid flow rate during fluid dispensation from a faucet of other fluid dispensing device.

What is needed therefore, but presently unavailable in the art, is a fluid dispensing apparatus and method for controlling the activation and inactivation of fluid flow, and optionally, the flow rate. Such an apparatus and method should be inexpensive to manufacture, reliable in operation, and should employ as much conventional hardware as possible. Such an apparatus should be easy to repair, and should also be capable of being repaired without replacing the entire apparatus. It is to the provision of such an apparatus and method that the present invention is primarily directed.

### SUMMARY OF THE INVENTION

One aspect of the present invention relates to an electronically controlled valve assembly. The electronically controlled valve assembly includes a valve cartridge including a valve, and a motor coupled to the valve cartridge to control movement of the valve in response to an electronic control signal..

In another aspect, the present invention relates to a method of electronically controlling fluid dispensation. The method includes the steps of sending an electronic signal from a controller to a motor coupled to a valve cartridge, the valve cartridge including a valve, and moving the valve with the motor in response to the electronic signal to permit or prohibit fluid flow through the valve cartridge.

In yet another aspect, the present invention is directed to an electronically controlled fluid dispensing apparatus. The electronically controlled fluid dispensing apparatus includes an electronically controlled valve assembly including a valve cartridge housing a valve, and a motor coupled to the valve cartridge to control at least one aspect of fluid dispensation from the valve. A controller communicates with the motor to provide electronic instructions for controlling movement of the valve.

Additional aspects of the present invention will be described in greater detail below with reference to the drawing figures.

The electronically controlled fluid dispensing apparatus and method of the present invention results in a number of advantages over other apparatus and methods commonly known in the art. For example, the electronically controlled fluid dispensing apparatus of the present invention utilizes a significant number of conventional fluid dispensing device components such as, but not limited to, off-the-shelf valve cartridges and conventional DC motors having low power requirements. As a result, control of flow and, if desired, flow rate, can be achieved at significant cost savings to the consuming public.

An additional advantage of the present invention is achieved by the use of conventional valve cartridges, such as, but not limited to ceramic valve cartridges (valve cartridges housing a ceramic disc insert) in lieu of a solenoid valve. As a result, reliability is improved, and flexibility is increased. In accordance with the preferred embodiment of the present invention, activation and inactivation of fluid flow and incremental control of flow rate may be achieved through the use of one or ceramic valve cartridges cooperating with a logic controlled motor. Such an arrangement in accordance with the preferred embodiment permits the use of a number of traditional plumbing components, which facilitates ease of component replacement due to ordinary wear and tear, replacement due to calcium build-up, and replacement due to increased demand for component upgrades.

Additional features and advantages of the invention will be set forth in the detailed description which follows and in part will be readily apparent to those skilled in the art from that description or recognized by practicing the invention as described herein.

It is to be understood that both the foregoing general description and the following detailed description are merely exemplary of the invention, and are intended to provide an overview or framework for understanding the nature and character of the invention as it is claimed. The accompanying drawings are included to provide further understanding of the invention, illustrate various embodiments of the invention, and together with the description serve to explain the principles and operation of the invention.

### BRIEF DESCRIPTION OF THE DRAWING FIGURES

The invention can be better understood with reference to the following drawings.

The elements of the drawings are not necessarily to scale relative to each other, emphasis instead being placed upon clearly illustrating the principles of the invention. Furthermore, like reference numerals designate corresponding parts throughout the several views.

FIG. 1 illustrates a conventional electronically controlled fluid dispensing apparatus.

FIG. 2 is a perspective view of a preferred valve assembly in accordance with the present invention.

FIG. 3 is a top view of the valve assembly depicted in FIG. 2 illustrating the cooperation of the motor and the valve cartridge.

FIG. 4 is a perspective view of two types of conventional ceramic valve cartridges that may be employed in accordance with a preferred embodiment of the present invention.

FIG. 5 is a schematic block diagram illustrating the various elements of a preferred electronically controlled fluid dispensing apparatus in accordance with the present invention.

FIG. 6 is cross-sectional view of a preferred valve housing depicting exemplary fluid flow paths when fitted with a ceramic valve cartridge as shown.

FIG. 7 is a block diagram illustrating an instruction execution system implementing the control logic of FIG. 5.

### DETAILED DESCRIPTION

Reference will now be made in detail to the present preferred embodiments of the invention, examples of which are illustrated in the accompanying drawing figures.

Wherever possible, the same reference numerals will be used throughout the drawing figures to refer to the same or like parts.

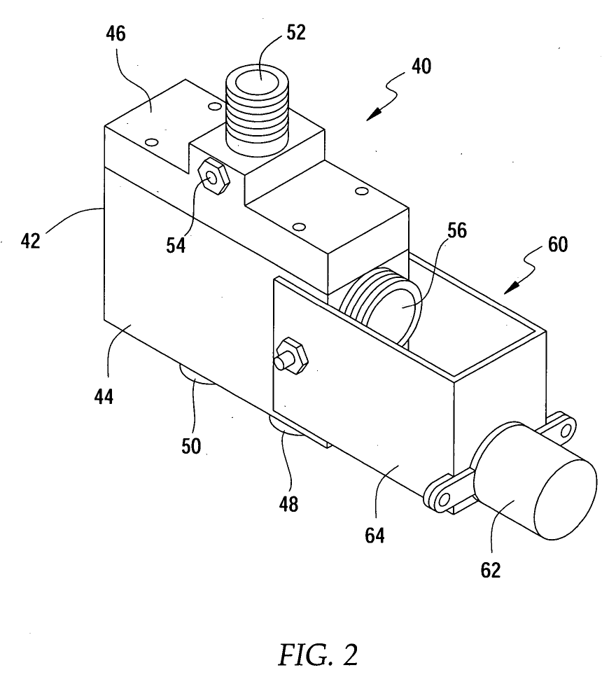

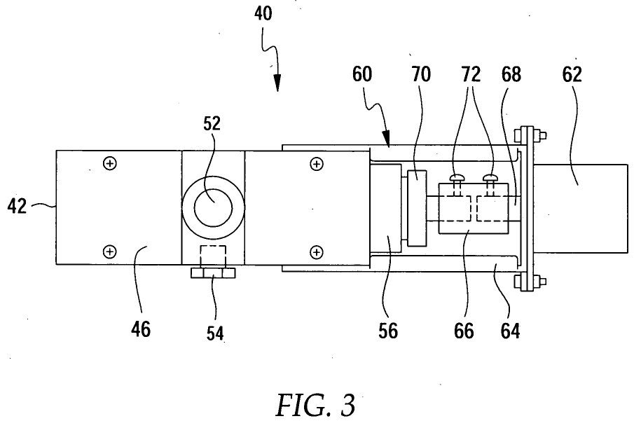

A preferred electronically controlled valve assembly 40 in accordance with the present invention is depicted in FIGS. 2 and 3. Although valve housing 42 is depicted in FIGS. 2 and 3 as being formed from two separate components, a mixing chamber 44 and a sensing chamber 46, valve housing 42 could be formed as a unitary component. In a preferred embodiment, valve housing 42 includes a cold water input 48 and a hot water input 50. This configuration facilitates mixing of a cold water stream and a hot water stream within mixing chamber 44 of valve housing 42, as will be described in greater detail below. One of skill in the art will recognize, however, that valve housing 42 may only include one fluid input. In such a case, only one fluid stream would be controlled by the electronically controlled valve assembly of the present invention. If desired, mixing of multiple fluid streams may be conducted upstream of such an electronically controlled valve assembly.

Returning again to the drawing figures, valve housing 42 also includes a fluid output, in this case a mixed fluid output 52. If desired, a sensor (not shown), such as a pressure sensor, temperature sensor (e.g., a Thermistor) or a combined pressure/temperature sensor may preferably be housed within a sensor housing 54 in order to measure the temperature and/or pressure of fluid passed through sensing chamber 46, and, if desired, to provide feedback to a controller to facilitate closed loop control of a fluid dispensing apparatus, as will be described in further detail below.

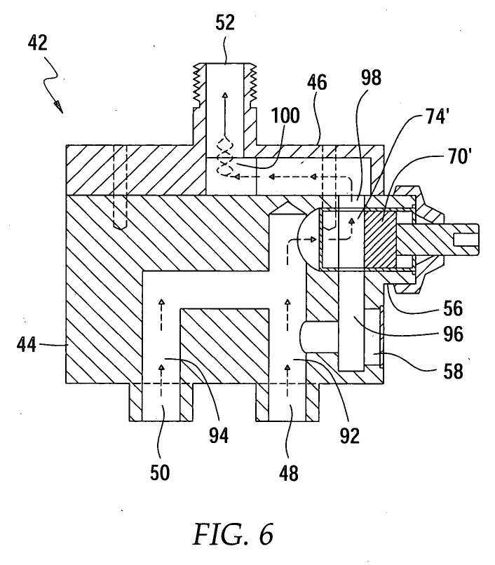

Electronically controlled valve assembly 40 further preferably includes one or more valve cartridge orifices such as valve cartridge orifice 56 and valve cartridge orifice 58 (FIG. 6). The valve cartridge orifices 56, 58 are preferably constructed and arranged to receive a conventional valve cartridge, the operation of which will be described below with reference to FIG. 6.

Electronically controlled valve assembly 40 further preferably includes a motor assembly 60 including a motor 62 and a motor mount bracket 64. As shown in the top view depicted in FIG. 3, motor 62 is mounted on motor mount bracket 64, which in turn, is coupled to valve housing 42 with bolts or other fasteners. As shown in FIG. 3, a linkage assembly 66 operably couples a drive member 68 of motor 62 to a valve cartridge 70 received within valve cartridge orifice 58 in valve housing 42. Valve cartridge 70 and drive member 68 may preferably be secured within linkage assembly 66 with screws or other fasteners 72.

As will be described in greater detail below, electronically controlled valve assembly 40 is preferably operated by a microprocessor based controller. Generally speaking, signals from the controller are communicated to the motor 62, which drives valve cartridge 70 via linkage assembly 66. In a preferred embodiment, valve cartridge 70 is rotated by motor 62, which opens and closes a passageway through valve cartridge 70, either initiating or terminating, respectively, fluid flow through electronically controlled valve assembly 40.

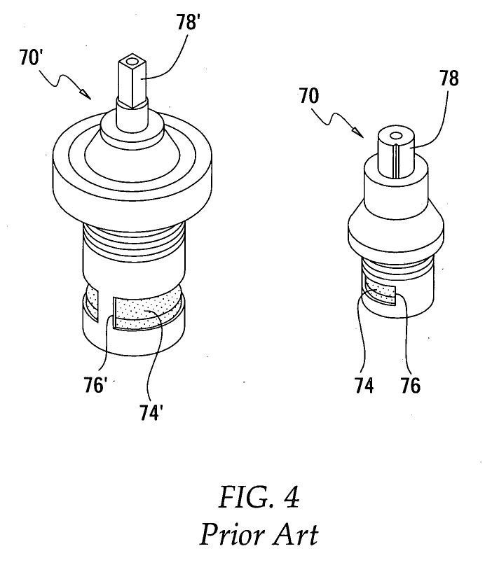

Two exemplary valve cartridges 70 and 70′ are more clearly depicted in FIG. 4. As shown clearly in the drawing figure, valve cartridge 70 differs significantly in design from valve cartridge 70′. Generally speaking, the functionality provided by valve cartridge 70 and 70′ are substantially equivalent, as is the functionality of other valve cartridges commonly known in the art. In a preferred embodiment of the present invention, valve cartridges 70 and 70′ are conventional ceramic valve cartridges which house a ceramic disc 74, 74′ and include one or more valve orifices 76, 76′. Each also preferably includes an engagement member 78, 78′.

Conventionally, valve cartridges 70, 70′ are employed in traditional manually operated faucets and are controlled by the faucet handle or handles. In accordance with the present invention, valve cartridges 70, 70′ are preferably controlled by an off-the-shelf DC motor in conjunction with controller electronics. Engagement members 78, 78′ are preferably rotated by motor 62, which in turn rotates ceramic disc 74, 74′ such that a passageway (not shown) through ceramic disc 74 or 74′ is aligned with valve orifices 76 or 76′ to provide a pathway for the flow of fluid. When engagement members 78, 78′ are counter-rotated by motor 62, ceramic discs 74, 74′ are counter rotated back to a closed position, which prevents fluid flow through valve orifices 76, 76′. As will be described in greater detail below, rotation of ceramic discs 74, 74′ within valve housing 42 may preferably enable on/off flow of fluid, and, optionally, control of flow rate of such fluid flow through valve housing 42.

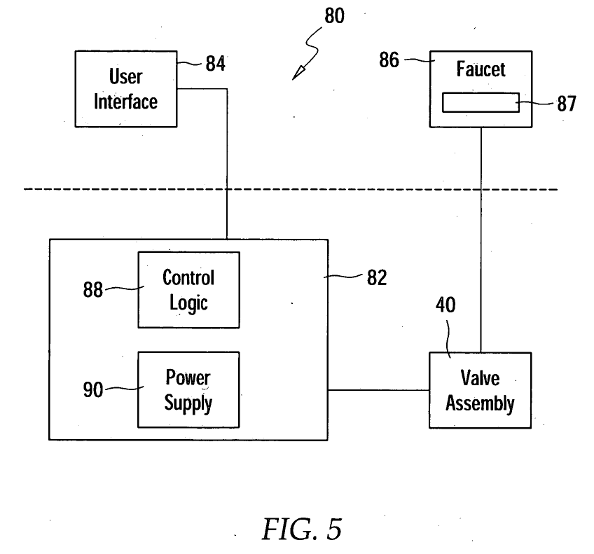

FIG. 5 schematically depicts an exemplary fluid dispensing apparatus 80 in accordance with the present invention, which in general, includes electronically controlled valve assembly 40 communicating with a microprocessor based controller 82. Although fluid dispensing apparatus 80 may incorporate any type of fluid dispensing device, fluid dispensing apparatus 80 will be described below as incorporating a faucet, and specifically, an automatically activated faucet incorporating sensing technology. Although any sensing technology is operative with the present invention, fluid dispensing apparatus 80 will further be described as utilizing conventional IR sensing technology. Generally speaking, fluid dispensing apparatus 80 will be activated and inactivated based upon whether or not the IR sensing technology detects the presence of an object in the vicinity of the faucet.

In its most simple form, activation will mean fully on and inactivation will mean fully closed. A user, however, may optionally provide a desired fluid or flow rate, via a user interface 84, to the controller 82 in order to control the flow rate characteristics of the fluid being dispensed, in addition to the on/off flow of fluid. The controller 82, in response to an IR detection signal, and/or the desires of the user, sends control signal(s) to the valve assembly 40, which utilizes the control signal(s) to position the valve insert, such as ceramic disc 74, 74′, in valve cartridge 70, 70′. When the fluid dispensing apparatus 80 is utilized to supply water to an outlet, such as a faucet 86, the input fluids to the valve assembly 40 are preferably cold water and hot water. The output of the valve assembly 40 may be a mixture of cold water and hot water, cold water or hot water.

In a preferred embodiment of the present invention, the user interface 84 may be a touch pad type user interface. The touch pad type interface preferably includes several keys for user input and a LCD display panel. Preferably, a user may select a desired flow rate and send the information to the controller 82. In addition this information may be stored in memory for later use. Such an arrangement may allow different users to have different stored settings for fluid dispensation at different flow rates. For example, a first setting could be used by a mother of a household, a second setting could be used by the father of the household, a third setting could be used by the son of the household, and a fourth could be used by the daughter of the household. A “Turn Off” key on the touch pad may be used to turn the water off or the water may be automatically turned off after a preset time value provided by a user or a technician that installs the fluid dispensing apparatus. Such flow settings from the touch pad could easily be stored in memory and selected with one or more key strokes.

In another embodiment the user interface 84 may be voice activated utilizing a microphone and speaker arrangement to select a desired water flow and water temperature setting. A variety of commands and the identity of the person speaking could be recognized by a voice recognition system. Outputs from the voice recognition system may then be furnished as input signals to the controller 82. Feedback to the user for such an embodiment may preferably be provided by a speaker.

In its simplest embodiment, however, dispensing apparatus 80 includes an electronically controlled valve assembly having a single valve cartridge 70 or 70′ that houses a ceramic disc 74 or 74′, and a motor 62 coupled to the valve cartridge to control the flow on and/or flow off of fluid dispensed from valve assembly 40. Motor 62 preferably rotates ceramic disc 74 or 74′ within valve cartridge 70 or 70′ to control fluid flow based upon electronic control signals provided by controller 82 as a result of IR detection signals transmitted from faucet 86. Such an apparatus 80 overcomes many of the shortcomings associated with conventional electronically controlled fluid dispensing apparatus incorporating solenoid valves.

The controller 82 includes control logic 88 and a power supply 90, such as, but not limited to, a battery pack. The control logic 88, power supply 90, such as a battery pack, and other conventional control electronics of controller 82 are preferably housed within a protective box. Among other things, the protective box allows limited access to the electronic components of controller 82 of the fluid dispensing apparatus 80, inhibits vandalism, and also provides a substantially dry environment for the electronic components housed therein.

While fluid dispensing apparatus 80 is applicable for use with any number of fluid dispensing devices, it is particularly well suited for, and will be described hereafter with respect to, its use in the field of water dispensing devices such as faucets 86 having IR sensing electronics 87 housed therein. Those of skill in the art will recognize that fluid dispensing apparatus 80 may also be applicable for use with showers, toilets, water coolers, and other fluid dispensing devices. This being said, and with reference to FIG. 6, a more detailed explanation of the operation of valve assembly 40 in conjunction with the other elements of fluid dispensing apparatus 80 will now be provided.

A preferred embodiment of valve housing 42 of valve assembly 40 is depicted in FIG. 6 in cross-section, and is shown fitted with a valve cartridge 70′. Cold water input 48 and hot water input 50 are preferably connected to the incoming cold and hot water lines, respectively, at the location where the valve assembly 40 is to be installed. As shown in FIG. 6, valve housing 42 is configured with a pair of valve cartridge orifices 56 and 58. Although not required, incorporating a plurality of different sized orifices provides flexibility for the user.

Generally speaking, and as shown in FIG. 4, conventional valve cartridges 70 and 70′ come in a variety of standard shapes and sizes. In accordance with one aspect of the present invention, a user may select which orifice 56 or 58 to utilize. Generally speaking, the decision will be based upon the type/size of valve cartridge 70 or 70′ the user has on hand. Moreover, providing this flexibility eliminates the need for multiple valve housing 42 designs. Instead, the same valve housing 42 may be utilized with several different valve cartridges 70, 70′. As will be described in greater detail below, only one valve cartridge, in this case, valve cartridge 70′ is necessary for the operation of the present invention. Accordingly, the unutilized valve cartridge orifice, and in this case, valve cartridge orifice 58 should be fitted with a valve cartridge 70 that is turned to the off position, or should be otherwise plugged to prevent undesired fluid flow from valve cartridge orifice 58. Those of skill in the art will recognize, however, that only one valve cartridge orifice 56 or 58 is necessary in accordance with this embodiment of the present invention. Accordingly, the specific design of the orifices and flow passageways that will be described below may take on any number of configurations without departing from the scope of the present invention.

Returning now to the operation of valve assembly 40, once cold water input 48 and hot water input 50 are connected to their respective feed lines (not shown), the water may be turned on such that cold water enters a cold water input cavity 92 and such that hot water enters a hot water input cavity 94. As shown in FIG. 6, the hot and cold water streams traverse the length of the cavities as indicated by the directional arrows in FIG. 6, and meet upstream of valve cartridge 70′. When no objects are sensed by the IR sensing electronics 87 of faucet 86, ceramic disc 74′ remains in the closed position and incoming water from input cavities 92 and 94 is prohibited from passing through valve cartridge 70′. When, however, IR sensing electronics 87 detect the present of an object adjacent faucet 86, a control signal is delivered from controller 82 to motor 62 (FIG. 3). The control signal activates motor 62 causing it to rotate ceramic disc 74′ within valve cartridge 70′, thereby opening valve cartridge 70′ and allowing the mixed hot and cold water (or hot or cold water) to pass through valve cartridge 70′ and into a mixed water output cavity 96 as shown by directional arrow 98. The water then proceeds from the mixed water output cavity 96 to a channel 100 defined within sensing chamber 46 of valve housing 42. The water then proceeds out mixed output 52 and into faucet 86 where it may be dispensed for a user. The water will continue to flow until the IR sensing electronics 87 no longer senses the presence of an object in the vicinity of faucet 86. At that time, one or more control signals will be delivered to motor 62 by controller 82 directing motor 62 to reverse polarity and rotate ceramic disc 74′ to close ceramic disc 74′ with respect to valve cartridge 70′, thereby terminating fluid flow through valve housing 42.

Although not shown in FIG. 6, a sensor housing 54 (FIGS. 2 and 3), which may hold a pressure sensor and/or a temperature sensor (not shown), may be positioned downstream of channel 100 to communicate with the water exiting mixed fluid output 52. When incorporated, such a temperature sensor can provide real-time temperature output data that may be displayed on the user interface 84, or provided as a feedback signal to the controller 82. Similarly, a pressure sensor may be used to provide real-time pressure output data that may be displayed on the user interface 84 (not shown), or provided as a feedback signal to the controller 82. Those of skill in the art will recognize that the temperature and pressure sensors may be co-located in a single housing.

In a preferred embodiment, a DC motor 62 may be controlled by a number of electronic signals provided by controller 82, each having a particular pulse width and associated voltage level. Typical valve cartridges 70 and 70′, such as those utilized in a preferred embodiment of the present invention, are one quarter turn cartridges, meaning that a one quarter turn of engagement member 78 or 78′ moves ceramic disc 74 or 74′ from a fully closed position to a fully opened position, or from a fully open position to a fully closed position, depending on the direction of the turn. Accordingly, it can readily determined, by experimentation and testing, for example, how many pulses, at a particular pulse width and voltage, will be necessary for motor 62 to move ceramic disc 74 or 74′ from a fully closed to a fully open position. Thus, if it is determined that 100 pulses, each having a pulse width of 5.0 microseconds and a known voltage are necessary to move ceramic disc 74 or 74′ from a fully open to a fully closed position, control logic 88 may be preprogrammed with that information so that when it receives a request to activate motor 62, it will automatically instruct controller 82 to successively deliver the 100, 5 microsecond pulses at the known voltage, thereby opening valve cartridge 70 or 70′.

Alternatively, controller 82 may provide pulses until an over-current condition is sensed. Generally speaking an over current condition would occur when ceramic disc 74 or 74′ reaches the fully open or fully closed position. Once the over-current condition is recognized by control logic 88, motor 62 would receive an instruction from controller 82 to disengage, and thus stop turning engagement member 78 or 78′.

Alternatively, pulse width modulation may be employed in accordance with another embodiment of the present invention. As known in the art, instead of utilizing numerous pulses, each having the same pulse width, pulse width modulation enables use of a single pulse having a variable pulse width. Accordingly, pulse width modulation may be particularly well suited for controlling not only the on/off state of fluid dispensing apparatus 80 of the present invention, but also its flow rate.

In another embodiment, an open loop control system may be implemented by applying a DC voltage to motor 42 driving ceramic disc 74 or 74′ associated with valve cartridge 70 or 70′, for a first selected period of time corresponding to a desired water flow rate. The rate of water flow is dependent on the characteristics of the DC motor, the water pressure, the specifications of the ceramic valve inserts and other factors. Look-up tables may preferably provide the correlation between the control signals, and the flow rates.

A feedback control system may alternatively be used to generate the control signals for motor position control that provides the desired flow rates. If the sensor housing 54 includes a sensor that provides both pressure and temperature information to the controller 82, the controller 82 may provide an actuating signal to minimize error between the desired flow rate and the actual flow rate. Since flow rate is proportion to pressure, the flow rate may be determined if the pressure is known. In other control systems it may be useful to have valve position sensors to provide feedback information. Those skilled in the art will recognize that other control methods, some of which may have other feedback information, may be used to provide a desired flow rate. Such variations in control methods would fall within the scope of the present invention. It would also be know to those skilled in the art, that while preferred motor 62 is a DC electric motor, other motors such as, but not limited to, hydraulic, or pneumatic motors may be used as well.

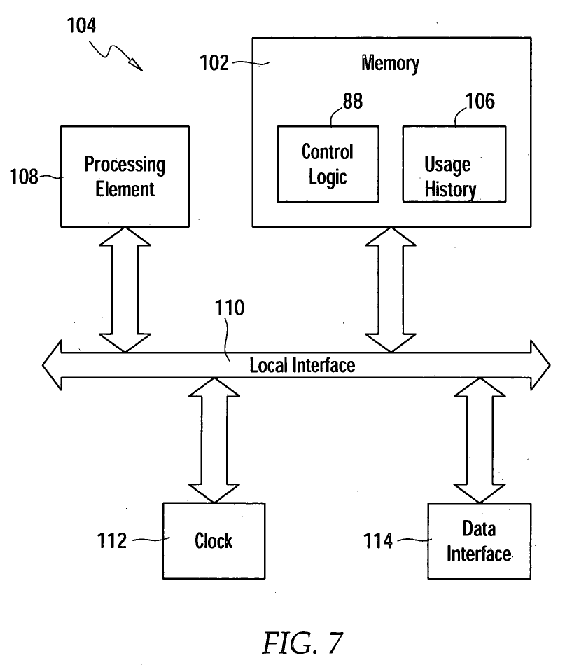

As shown in FIG. 5, the controller 82 includes control logic 88 configured to control the operation and functionality of the controller 82. The control logic 88 may be implemented in software, hardware, or a combination thereof. In the preferred embodiment, as illustrated by way of example in FIG. 7, the control logic 88, along with its associated methodology, is implemented in software and stored in memory 102 of an instruction execution system 104, such as a microprocessor, for example. A portion of memory 102 may also be available for storing usage history 106 that may provide a maintenance technician with information about the fluid dispensing apparatus 80.

Note that the control logic 88, when implemented in software, can be stored and transported on any computer-readable medium. In the context of this disclosure, a “computer-readable medium” can be any means that can contain, store, communicate, propagate, or transport a program. The computer readable-medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory. As an example, the control logic 88 may be magnetically stored and transported on a conventional portable computer diskette.

The preferred embodiment of the system 104 of the present invention, and as shown in FIG. 7, includes one or more conventional processing elements 108, such as a central processing unit (CPU), that communicate to and drive the other elements within the system 104 via a local interface 110, which can include one or more buses. Furthermore, the system 104 may include a clock 112 that may be utilized to, among other things, to track time and/or control the synchronization of data transfers within the system 104. The system 104 may also include one or more data interfaces 114, such as analog and/or digital ports, for example, for enabling the system 104 to exchange data with the other elements of the controller 82.

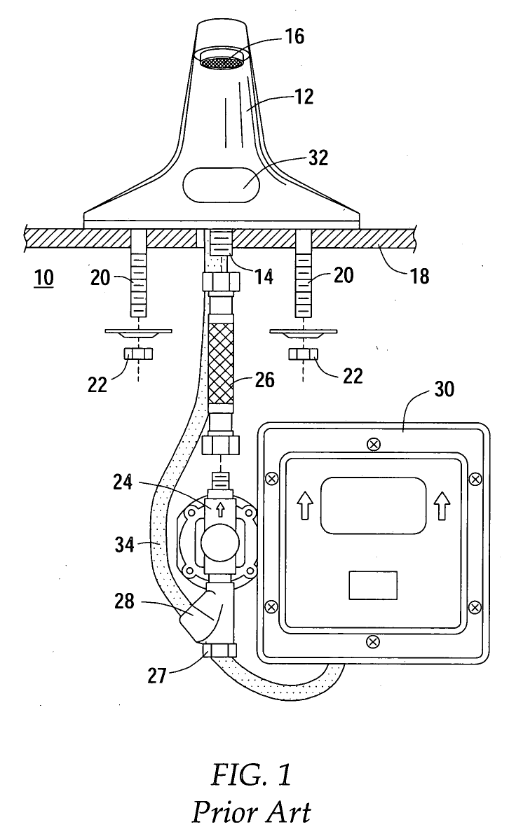

While the invention has been described in detail, it is to be expressly understood that it will be apparent to persons skilled in the relevant art that the invention may be modified without departing from the spirit of the invention. Various changes of form, design or arrangement may be made to the invention without departing from the spirit and scope of the invention. For example, the invention as described is not dependent upon specific hardware configurations, nor is it pivotal to employ a specific programming language to implement the invention as described. Moreover, and although not described above, existing conventional electronically controlled fluid dispensing devices employing solenoid valves, such as the one depicted in FIG. 1, may be easily and readily retrofit for operation in accordance with the present invention. Generally speaking, retrofitting a presently installed conventional fluid dispensing device would merely require the replacement of the solenoid valve with electronically controlled valve assembly 40 of the present invention and reconfiguration of the control electronics and control logic such that they provide the functionality described above. Therefore, the above mentioned description is to be considered exemplary, rather than limiting, and the true scope of the invention is that defined in the following claims.

What is claimed is:

1. An electronically controlled valve assembly comprising:
a valve cartridge including a valve; and
a motor coupled to the valve cartridge to control movement of the valve in response to an electronic control signal.

2. The electronically controlled valve assembly of claim 1 wherein the valve comprises a ceramic valve insert.

3. The electronically controlled valve assembly of claim 2 wherein the ceramic valve insert comprises a ceramic disc.

4. A method of electronically controlling fluid dispensation, the method comprising the steps of:
sending an electronic signal from a controller to a motor coupled to a valve cartridge, the valve cartridge including a valve; and
moving the valve with the motor in response to the electronic signal to permit or prohibit fluid flow through the valve cartridge.

5. An electronically controlled fluid dispensing apparatus comprising:
an electronically controlled valve assembly including a valve cartridge housing a valve and a motor coupled to the valve cartridge to control at least one aspect of fluid dispensation from the valve; and
a controller communicating with the motor to provide electronic instructions for controlling movement of the valve.

6. The electronically controlled fluid dispensing apparatus of claim 5 wherein the valve comprises a ceramic valve insert.

7. The electronically controlled fluid dispensing apparatus of claim 6 wherein the ceramic valve insert comprises a ceramic disc.
